(19) United States
(12) Patent Application Publication
(10) Pub. No.: US 2026/0238506 A1
(43) Pub. Date: Aug. 13, 2026

(54) METHODS AND SYSTEMS FOR POLICY AND CHARGING CONTROL RULE GENERATION

(71) Applicant: Telefonaktiebolaget LM Ericsson (publ), Stockholm (SE)

(72) Inventors: Rémi ROBERT, Solna (SE); Arif AHMED, Kista (SE)

(21) Appl. No.: 19/147,949

(22) PCT Filed: Jan. 17, 2023
(86) PCT No.: PCT/EP2023/051027

§ 371 Date: Jul. 14, 2025

(51) Int. Cl. H04L 12/14; H04W 4/24

(52) U.S. Cl. CPC H04L 12/1407; H04W 4/24

(57) ABSTRACT

Embodiments include methods, electronic device, storage medium, and computer program for policy and charging control rule generation. In one embodiment, a method is to be implemented for policy and charging control rule generation, the method comprising: receiving a first policy and charging control rule that identifies an edge application, a location of the edge application, and policy information for the edge application; generating a second policy and charging control rule for a user equipment (UE) interacting with an edge application server of the edge application based on the first policy and charging control rule, the second policy and charging control rule identifying the policy information for the edge application and an Internet Protocol (IP) address corresponding to the edge application server; and causing application of the second policy and charging control rule on a traffic flow between the UE and the edge application server.

### TECHNICAL FIELD

Embodiments of the invention relate to the field of networking and more specifically, to generating policy and charging control rules.

### BACKGROUND ART

Charging is a basic function to allow a service provider (e.g., a mobile network operator (MNO)) to get payment from a subscriber of a network based on the service provided to the subscriber by the service provider. The charging may be based on characteristics of the traffic flow (also referred to simply as flow) between a subscriber (e.g., a user equipment (UE)) and an edge application. Multiple edge application servers may be initiated for a single edge application (e.g., in order to scale service delivery in various locations).

Charging rules allow the service provider to apply different billing rates for edge application servers at different locations. For example, when the location of the edge application server that delivers a service to a first UE is closer to the first UE than a second UE that gets the same service from the same edge application server, the first UE may be charged at a lower rate for the traffic flow using the same bandwidth than the second UE, given that the former consumes less resources of the network to provide the service.

The location of an edge application server can often be identified based on the Internet Protocol (IP) address of the edge application server, thus a charging rule or another policy and charging control (PCC) rule may be created to map to the IP address of the edge application server. Yet the IP address of an edge application server is often known only after the edge application server is instantiated for an edge application, which is during runtime. The IP address-based PCC rule may not be known during the configuration stage. Additionally, an edge application server, as an instance of the edge application, may be added and removed dynamically during runtime. And the dynamic nature of the edge application deployment is also reflected in the mobility of subscribers. A mobile device such as UE may roam from one locale to another where another edge application server of the same edge application (with a different IP address) is more desirable than the one included in the known PCC rule. Because of these features of edge application deployment, it is often impractical or cumbersome to create and maintain the IP address-based PCC rules manually, thus making applying these PCC rules unwieldy and hard to scale in a mobile network.

### SUMMARY OF THE INVENTION

Embodiments include methods, electronic device, storage medium, and computer program for policy and charging control rule generation. In one embodiment, a method is to be implemented in a network node of a network for policy and charging control rule generation, the method comprising: receiving a first policy and charging control rule that identifies an edge application, a location of the edge application, and policy information for the edge application; generating a second policy and charging control rule for a user equipment (UE) interacting with an edge application server of the edge application based on the first policy and charging control rule, the second policy and charging control rule identifying the policy information for the edge application and an Internet Protocol (IP) address corresponding to the edge application server; and causing application of the second policy and charging control rule on a traffic flow between the UE and the edge application server.

In one embodiment, a network node comprises a processor and machine-readable storage medium that provides instructions that, when executed by the processor, are capable of causing the processor to perform operations of: receiving a first policy and charging control rule that identifies an edge application, a location of the edge application, and policy information for the edge application; generating a second policy and charging control rule for a user equipment (UE) interacting with an edge application server of the edge application based on the first policy and charging control rule, the second policy and charging control rule identifying the policy information for the edge application and an Internet Protocol (IP) address corresponding to the edge application server; and causing application of the second policy and charging control rule on a traffic flow between the UE and the edge application server.

In one embodiment, a machine-readable storage medium that provides instructions that, when executed by a processor, are capable of causing the processor to perform operations of: receiving a first policy and charging control rule that identifies an edge application, a location of the edge application, and policy information for the edge application; generating a second policy and charging control rule for a user equipment (UE) interacting with an edge application server of the edge application based on the first policy and charging control rule, the second policy and charging control rule identifying the policy information for the edge application and an Internet Protocol (IP) address corresponding to the edge application server; and causing application of the second policy and charging control rule on a traffic flow between the UE and the edge application server.

Embodiments of the invention automatically generate an optimized set of IP address-based policy and charging control (PCC) rules for an edge application server based on a PCC rule for the corresponding edge application and identify the IP address of the edge application server. Such automatic PCC rule generation is better than manually setting up IP address-based PCC rules as the automatic PCC rule generation is simpler for the network operator, more computationally effective, and/or consuming less network resources than the configuring IP address-based PCC rules manually.

### BRIEF DESCRIPTION OF THE DRAWINGS

The invention may best be understood by referring to the following description and accompanying drawings that are used to illustrate embodiments of the invention. In the drawings:

FIG. 1 illustrates an architecture for policy and charging control rule generation per some embodiments.

FIG. 2 illustrates operations to generate IP address-based charging rules per some embodiments.

FIG. 3 is a flow diagram illustrating operations to generate a policy and charging control rule per some embodiments.

FIG. 4 illustrates a network node implementing adaptive fault remediation per some embodiments.

FIG. 5 illustrates an example of a communication system per some embodiments.

FIG. 6 illustrates a UE per some embodiments.

FIG. 7 illustrates a network node per some embodiments.

FIG. 8 is a block diagram of a host, which may be an embodiment of the host of FIG. 5, per various aspects described herein.

FIG. 9 is a block diagram illustrating a virtualization environment in which functions implemented by some embodiments may be virtualized.

FIG. 10 illustrates a communication diagram of a host communicating via a network node with a UE over a partially wireless connection per some embodiments.

### DETAILED DESCRIPTION

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features, and advantages of the enclosed embodiments will be apparent from the following description.

### Policy and Charging Control Rules for Traffic Flows

Embodiments of the invention generate one or more policy and charging control (PCC) rules for an edge application server (EAS) based on one or more PCC rules for an edge application (EA) that instantiates the EAS. The EAS may also be referred to as the EAS instance or EA instance as it represents an instance created to provide the edge application. The former rules are also referred to as low-level PCC rules applicable to traffic flows as they are specific to a particular EAS of the EA, while the latter rules are also referred to as high-level PCC rules to be generic to the EA. Note that these PCC rules applicable to traffic flows are also referred to as flow-based PCC rules, and unless specified otherwise, the PCC rules discussed herein refer to the ones applicable to traffic flows (e.g., a traffic between flow between an EAS and a UE).

While the embodiments are explained using charging rules as examples herein, the embodiments may be applicable to other PCC rules applicable to a traffic flow such as ones for packet forwarding, packet buffering, authorized Quality of Service (QoS), and other policies for the traffic flow. The PCC rules herein cover the PCC rules in standards such as ones defined for the Fifth Generation (5G) networks (e.g., the 3rd Generation Partnership Project (3GPP) standards the Technical Specification (TS) 23.503 entitled “Policy and charging control framework for the 5G System”), and for the Fourth Generation (4G) networks (e.g., policy and charging rules function (PCRF) in Long-Term Evolution (LTE)), and the PCC rules defined for a traffic flow in a proprietary network. For illustration, the function blocks defined in a 5G network are shown for performing the operations, including the session management function (SMF) and network exposure function (NEF). In alternative embodiments, other functions may perform the operations as well.

The PCC rules may be applied to charge for a traffic flow between a User Equipment (UE) and an EAS, which is instantiated from an EA. An EAS includes an application server that resides in the edge hosting environment close to the UE to be served (e.g., closer to the UE than other servers offered by a cloud provider). The EAS is external to a network operated by the mobile network operator (MNO) in some embodiments.

Multiple EASes may be instantiated for a given EA, at different locations with different IP addresses in the edge hosting environment, while an EAS maintains the same IP address during the lifetime of the EAS. The IP address of an EAS is the IP address of an interface of the EAS through which a traffic flow between a subscriber (e.g., a UE) and the EAS may be processed. One of the EASes may be selected to serve the UE through the traffic flow. The selection of the EAS from the multiple EASes may be based on one or more factors, e.g., the distance between the EAS and UE locations, where different charging rates may be applied based on the EAS location.

Note that in many systems, the EAS location cannot be inferred solely from the location of the user plane function (UPF) through which the traffic of the UE is reaching the EAS, as the UPF may be shared by multiple applications or application servers, and there is no one-to-one mapping between UPF and EAS (unless one UPF instance uniquely maps to one EAS). Thus, in these systems, the location-based information of the UPF (e.g., the IP address of the UPF) can't be used to determine the location of the corresponding EAS.

The charging for the traffic flow between the EAS and UE may be based on application detection, yet such approach faces several challenges.

### Application Detection and Shortcomings in Applying IP Address-Based Charging

The traffic flow from a UE to an EAS may be detected through determining Open System Interconnect (OSI) Layers 3 and/or 4 identifiers (e.g., IP address, port number, protocol type) and/or application-level identifier (e.g., domain name) of the EA/EAS. An application-level identifier for the application detection may be found through techniques such as Deep Packet Inspection (DPI), which extracts from packets of the traffic flow (1) the HyperText Transfer Protocol (HTTP) header and/or (2) Transport Layer Security (TLS) Server Name Indication (SNI). A charging rule may be set for the traffic flow using the IP address of the EAS, and then charge may be applied to the traffic flow based on the charging rule.

Yet as we discussed in the Background Art, the manual creation of an IP address-based charging rule is unwieldy and hard to scale in a mobile network. Additionally, encryption has been implemented ever more widespread over time and the application-level identifier may not be detectable through DPI.

Furthermore, the existing management functions such as the SMF in a 5G network are not provided with EAS attributes such as the IP address of an EAS. These function blocks thus can't differentiate between the different locations of the EASes when reporting to the Charging Function (CHF). For example, the SMF only has access to information about the edge application (EA) that are provided as part of the associated charging rule in service data flow detection as shown in the following:

| | Information about the detection |
|---|---|
| Service Data flow detection | of an EA traffic |
| Application Identifier | Identifier referring to a specific |
| | application detection filter |
| | Information used in charging |
| Charging | and accounting |
| Charging key | Used by the CHF to determine |
| | the tariff to apply |
| Service identifier | Identifier of the service the |
| | rule relates to (could be |
| | the EA ID) |
| Application service | Identifier for the Application |
| provider identifier | Service provider |

Performing charging uses the EAS IP address of the serving EAS instantiated from the EA. For example, the EAS IP address may be the source IP address for a downlink traffic flow to a user equipment (UE) or the destination IP address for an uplink traffic flow from the UE as shown in the application detection filter in the following:

| | Parameters used by the filter to |
|---|---|
| Application Detection Filter | detect the traffic from an application |
| Source IP address | |
| or prefix | |
| Destination IP | |
| address of prefix | |
| Source port | |
| Destination port | |
| Protocol number | |
| HTTP Host | Domain name in an HTTP |
| | Request Host header |
| TLS SNI | SNI in a TLS client |
| | Hello message |

Since the SMF does not have access to information about the EAS, the EAS location (e.g., indicated through the EAS IP address) is not an input that can be considered in the rating process, even indirectly (e.g., through management functions such as the SMF). It is thus challenging to generate an IP address-based charging rule (or another PCC rule) automatically and apply it to a traffic flow between the EAS and the UE.

However, it is observed that the IP address of an EAS can be determined through an EAS discovery process.

### EAS Discovery

A few methods have been implemented to discover the IP address of an EAS to route the traffic flow to the EAS:
(1) An Edge Application Server Discovery Function (EASDF) may augment and forward a domain name system (DNS) query from the UE to a proper DNS server, which resolve the IP address of the EAS most suitable for the UE (e.g., the closest to the UE).
(2) Instead of relying on the EASDF, the UE may discover the address of the EAS based on a local DNS server, which resolves the IP address of the EAS. The user plane setup is assumed to be performed in advance, independently of the EAS discovery.
(3) Additionally, UE may query a dedicated network node, the Edge Enabler Server (EES), for a list of suitable EASes and select one that is preferable (e.g., the closest one). This process is completely independent of the user plane setup (unlike (2) above).

Instead of obtaining the IP address through the EAS discovery process for the UE only, the IP address of the EAS may be provided to the SMF (or another management function) in some embodiments. The additional information allows the SMF to use the IP address to resolve a charging rule configured for an EA (a high-level PCC rule) to generate a charging rule configured for an EAS of the EA (a low-level PCC rule). Based on the information from the EAS discovery process, the SMF may configure the user plane path for the UE (e.g., setting up an uplink-downlink (UL-DL) classifier and changing the UPF chain) and cause the corresponding traffic flow to be charged according to the IP address of the EAS.

The added usage of EAS discovery leverages existing methods and makes the PCC rule generation more efficient, portable, and/or scalable as the high-level PCC rules (targeting EAs) may be provided during the configuration stage while the corresponding low-level PCC rules (targeting EASes) may be generated automatically without human intervention based on the high-level PCC rules in the runtime.

### Architecture for Policy and Charging Control Rule Generation

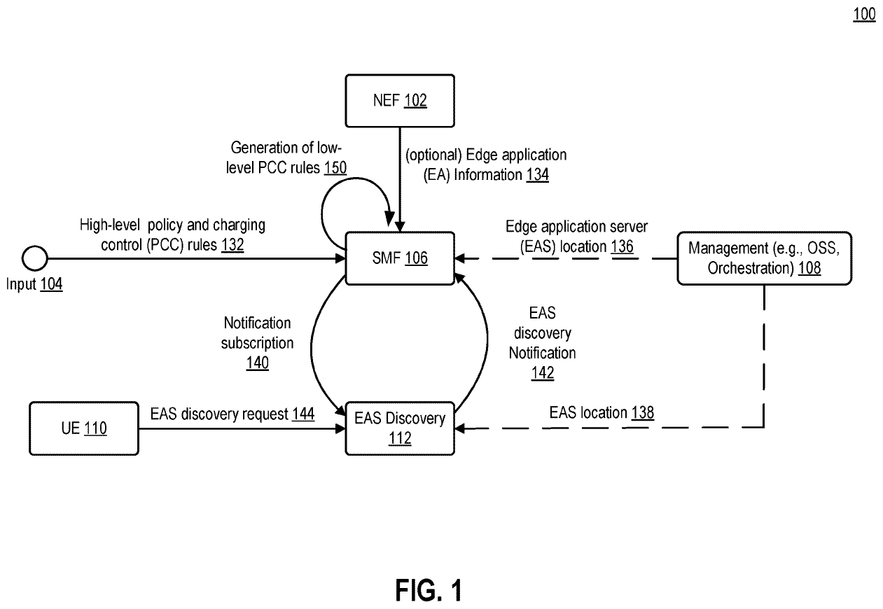

FIG. 1 illustrates an architecture for policy and charging control rule generation per some embodiments. The architecture 100 implements the 5G and 5G function blocks are shown for the PCC rule generation. As noted, similar architectures may be used for PCC rule generation in the 4G or proprietary networks in some embodiments.

The session management function (SMF) 106 is the regular node from 3GPP enhanced with the additional capabilities to obtain IP addresses of edge application servers (EASes) instantiated from corresponding edge applications (EAs).

The network exposure function (NEF) 102 allows the SMF 106 to query for information regarding an edge application based on an identifier. For example, NEF 102 may get a domain name of an edge application based on an identifier (ID) of the edge application.

The domain name of the edge application may be the fully qualified domain name (FQDN) in some embodiments. The FQDN (also referred to as an absolute domain name) is a domain name that specifies the edge application's exact location in the tree hierarchy of the Domain Name System (DNS). The FQDN specifies all domain levels, including the top-level domain and the root zone. A fully qualified domain name is distinguished by its lack of ambiguity in terms of DNS zone location in the hierarchy of DNS labels. A FQDN is conventionally written as a list of domain labels separated using the full stop “.” The obtainment of the domain name of an edge application based on the ID of the edge application is specified in standards, e.g., 3GPP TS 23.548 entitled “5G System Enhancements for Edge Computing.”

The management module 108 represents the management system in charge of supporting the Edge Cloud deployment of the edge application. The management module 108 may notify another system/function (e.g., 5G core function blocks such as NEF 102 and SMF 106) of some of the lifecycle events of the corresponding edge application (e.g., when no EASes have been instantiated yet) or EASes. The management module 108 may be owned by the MNO or belong to a separate entity responsible for the handling of the Edge Cloud. In some embodiments, the management module 108 is implemented as a part of orchestration module or operational support systems (OSS) of the MNO or the separate entity.

The EAS discovery 112: Depending on the solution being used, this role could be played by different components, and these different components are defined in standards. For example, the EAS discovery 112 may be (1) EASDF or DNS server defined in 3GPP TS 23.548, or (2) EES defined in 3GPP TS 23.558, entitled “Architecture for enabling Edge Applications.” In some embodiments, the EAS discovery 112 is configured with the capability to accept notification rules from the SMF 106 and notify it when producing an EAS discovery response that matches a rule.

UE 110 is a subscriber of edge applications. To do so, it originates EAS discovery requests, which may trigger notifications from the EAS discovery 112 to the SMF 106.

Input 104 provides high-level policy and charging control (PCC) rules to the SMF 106 at reference 132. Input 104 may be a user interface (e.g., a graphic user interface (GUI) or a common line interface), through which an operator enters the high-level PCC rules. Alternatively, input 104 can be an interface to receive automated generated high-level PCC rules (e.g., based on event notifications/interrupts).

An example of the high-level PCC rules is a charging rule like the following:
Target: EA_Drone_Traffic_Management.
Location: DataCenter_A
Charging_key: EA_Expensive

The charging rule for an edge application indicates the identifier (ID) of the edge application (the target), the location of the edge application (a data center location without specifying the corresponding IP address), and the charging key of the edge application. The charging key maps to a charging rate, which in this case corresponds to “expensive.”

In some embodiments, the charging rule does not have enough information for the SMF 106 to generate a low-level charging rule. In that case, the SMF 106 obtains edge application information from the NEF 102 at reference 134 based on the edge application ID. For example, depending on the available EAS discovery methods, different additional information may be needed. In some embodiments, the additional information includes the domain name of the edge application (e.g., the EASDF and local DNS based approaches discussed herein). In some embodiments, the domain name is the FQDN of the edge application, e.g., dronetraffic.awesome_co.com.

The SMF 106 may generate and push one or more notification rules as notification subscriptions at reference 140 to the EAS discovery 112 based on the charging rule, including one or more of the following:
Toward the EASDF to get notification on resolution of the given domain name (e.g., dronetraffic.awesome_co.com) to get the IP address of the corresponding EAS most suitable to the UE;
Toward the local DNS server to get notification on resolution of the given edge application to get the IP address of the corresponding EAS most suitable to the UE; and
Toward the EES to get notification on discovery of the edge application based on the edge application ID to get the IP address of the corresponding EAS most suitable to the UE.

The one or more notification subscriptions causes EAS discovery notification 142 to send back to the SMF 106 when an EAS is identified (e.g., in response to an EAS discovery request 144). Based on the EAS discovery notification 142, the SMF 106 generates one or more low-level PCC rules for the traffic flow between UE 110 and the EAS.

Note that as discussed herein above, multiple EASes may be instantiated for a given EA, at different locations with different IP addresses in the edge hosting environment, and the obtained IP address of the most suitable EAS maps to the EAS location. Thus, the IP address of the EAS by itself is sufficient to determine the EAS location for charging and other PCC rules. While the notification rules are for the IP address of the single most suitable EAS in some embodiments, in alternative embodiments, the notification rules cause the IP addresses of multiple EASes of an edge application to be sent to the SMF 106.

When an EAS is created to provide the corresponding edge application (EA), the SMF 106 is notified with information such as the following:
Identifier: EA_Drone_Traffic_Management or dronetraffic.awesome_co.com
EAS address: 192.0.2.123
Location: DataCenter_A

When UE 110 discovers the EAS (e.g., through the EAS discovery request 144), the SMF 106 is notified with the following information through EAS discovery notification 142 in some embodiments:
Identifier: EA_Drone_Traffic_Management or dronetraffic.awesome_co.com
EAS address: 192.0.2.123

Note that in some embodiments, the SMF 106 may cause the management module 108 to provide the IP address of the most suitable EAS (e.g., with ID of EA_Drone_Traffic_Management or dronetraffic.awesome_co.com), either directly to the SMF 106 as shown at reference 136, and/or the management module 108 may provide the IP address of the most suitable EAS to the EAS discovery 112 at reference 138. In the latter case, the EAS discovery 112 provides IP address of the most suitable EAS to the SMF 106 through EAS discovery notification 142.

The SMF 106 may obtain the IP address of the most suitable EAS from the management module 108 through setting notification rules in some embodiments. For example, SMF 106 may subscribe to notifications from the management module 108 regarding lifecycle events for the EAS, including EAS termination and removal of the associated low-level charging rules when an EAS is destroyed.

The SMF 106 queries its internal state for a matching EA instantiation notification, based on the IP address (192.0.3.123) and retrieves the EAS location (here DataCenter_A). The SMF 106 then queries its internal state for a rule that matches the identifier and location and retrieves the high-level charging rule above. The SMF 106 will generate and activate a low-level charging rule:
Traffic_filter: ip.host: 192.0.2123
Charging_key: EA_Expensive

The low-level charging rule is then used to charge the traffic flow between UE 110 and the identified EAS with IP address of 192.0.2.123 with the charging key “EA_Expensive.” The traffic identification, usage reporting, and charging then happens based on the low-level charging rules.

Note that while the high-level and low-level charging rules are used to illustrate the embodiments in this example, other low-level PCC rules may be generated based on the corresponding high-level PCC rules.

The embodiments as discussed allow for a PCC rule generation function (e.g., the SMF 106 or another management function with similar functions) to handle high-level charging rule identifying an edge application through a high-level identifier (e.g., domain name, EAS ID), and with the rule possibly being dependent on the location of the instance handling the flow (e.g., to associate different charging keys to the different locations).

To detect the traffic going to a given edge application, the PCC rule generation function may rely on the existing EAS discovery functions (e.g., using the EASDF, using a local DNS, using the EES, or through a management module) to be notified when a UE discovers one/multiple local instances of an edge application. Upon reception of this notification (including the IP address of the EAS), the PCC rule generation function can generate the appropriate application detection filters at the IP level.

Further, leveraging the IP addresses received in the notification from the EAS discovery function and the EAS creation notifications previously received from the management module, the PCC rule generation function can identify the location of the deployment of the associated EAS or EASes. The PCC rule generation function then may generate and activate an optimized set of low-level charging rules based on the high-level rules, generated application detection filters, and locations.

Thus, the PCC rule generation function (e.g., SMF 106) may automatically generate an optimized set of low-level PCC rules for an edge application based on a high-level PCC rule with high-level identifier of the edge application (e.g., its fully qualified domain name or EA ID) and identification of the location of the associated EAS.

The advantages of such PCC rule generation function include not relying on deep packet inspection (DPI) for application detection, since DPI may be unavailable (due to the adoption of encrypted protocols) and is comparatively more computationally expensive than the IP address-based rule generation. Also, compared to manually setting up IP address-based rules, the automatic rule generation is (1) simpler for the network operator (e.g., MNO), (2) more computationally effective as the rules may be generated without requiring a-priori knowledge of all the IP addresses used by the EASes of an edge application, and/or (3) consuming less network resources (storage/bandwidth/processing resources are consumed to create the EASes) only creating the rules for EASes that are actively used.

Additionally, such PCC rule generation function allows the incorporation of the EAS location as an input to the charging process, which makes it possible for the network operator to apply different rates depending on the EAS location.

### Operations in Exemplary Charging Rule Generation

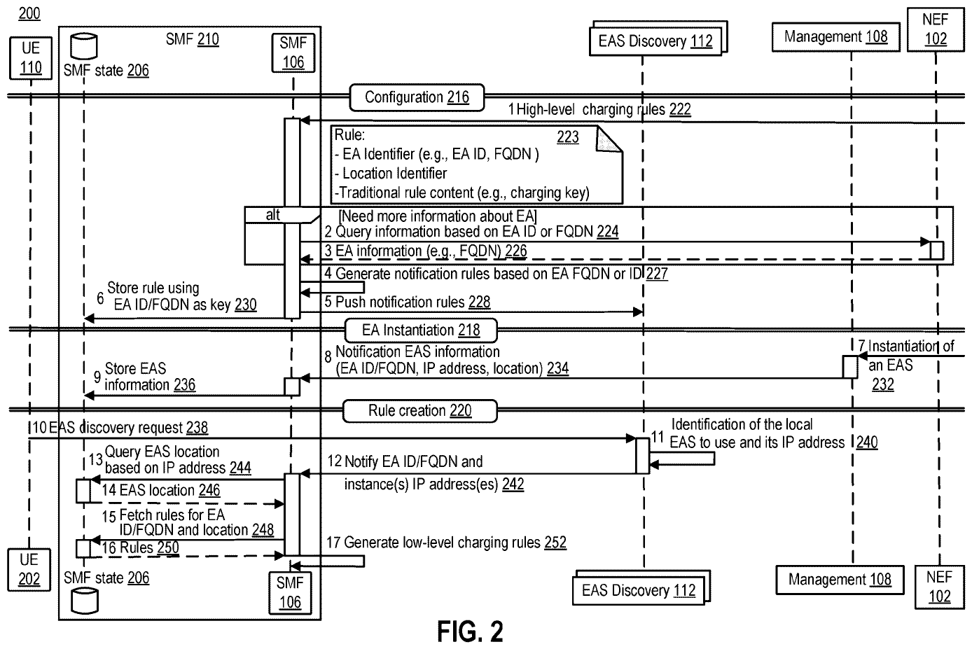

The architecture 100 as shown may be implemented differently for different PCC rules. FIG. 2 illustrates operations to generate IP address-based charging rules per some embodiments. The figure shows the same blocks as in FIG. 1, and they may perform operations the same as or similar to the ones performed as discussed relating FIG. 1. Different from FIG. 1, FIG. 2 shows the SMF state (also referred to the SMF's internal state as above) 206 of SMF 106 that is saved in a datastore.

A datastore is typically intended to store data (which may be voluminous) for possible consumption by multiple clients/subscribers. Datastores include those which typically persist data (e.g., an on-disk database) and those which typically do not persist data (e.g., an in-memory database, a streaming platform, a key-value datastore, a document store, etc.). The datastore may be coupled but external to the SMF 106 in some embodiments. In alternative embodiments, the datastore is a part of an SMF, SMF 210.

FIG. 2 shows three stages of rule generation: configuration 216, edge application instantiation 218, and rule creation 220. Steps 1 to 17 indicate the order of operations per some embodiments.

### Configuration

In the configuration stage, the high-level charging rules are provided to the SMF 106. Through configuration, SMF 106 does the preparation needed to dynamically generate the low-level IP-based charging rules when needed.

At Step 1 (Reference 222), the SMF 106 is provisioned with one or more high-level charging rules. As shown at reference 223, a high-level charging rule contains (1) an identifier of an edge application (EA) (e.g., FQDN, EA ID), (2) an identifier indicating the location of the edge application for which this rule applies, and (3) traditional content that can already be found in existing rules (e.g., charging key). While a single high-level charging rule is used as example to discuss the operations, multiple high-level charging rules may be set up in configuration and each may be converted into one or more low-level charging rules.

At Step 2 (Reference 224), if the identifier used in the high-level charging rule is insufficient for the execution of the next steps (depending on the solutions used for the EAS discovery), the SMF 106 queries the NEF 102 for additional information about the edge application based on the identifier.

The additional information may the one needed to identify the edge application when subscribing to the EAS discovery events from the different sources (and could also be used when subscribing to the edge application lifecycle events). For example, the additional information may be EA Identifier (ID) used to subscribe to the EAS discovery events coming from the EES, or edge application domain name used to subscribe to the discovery events coming from the DNS based mechanisms (e.g., EASDF).

At Step 3 (Reference 226), the NEF 102 provides the additional information (e.g., to obtain FQDN based on the EA ID).

At Step 4 (Reference 227), the SMF 106 generates one or more notification rules that are required for the runtime stage operations, based the high-level charging rule and additional information. For one high-level charging rule, there could be multiple notification rules, targeting the different EAS discovery solutions. As discussed herein above, the notification rules may include one or more of the ones toward the EASDF, the local DNS server, the EES, and the management module.

At Step 5 (Reference 228), the SMF 106 pushes the notification rules to the EAS discovery 112. The EAS discovery 112 may be the EASDF or DNS server or EES discussed herein above.

At Step 6 (Reference 230), the SMF 106 stores the high-level charging rule to the datastore of the SMF 106 as SMF state. The high-level charging rule may be stored using the edge application (EA) ID or FQDN of the EA as its search key.

### Edge Application Instantiation

In this stage, an edge application server (EAS), which is an instance of the edge application, is created. The management module 108 notifies the SMF 106, which stores the information in its state.

At Step 7 (Reference 232), the EAS is instantiated based on a trigger (e.g., an event notification or an interrupt), and the management module 108 becomes aware of the newly created EAS.

At Step 8 (Reference 234), the management module 108 notifies the SMF 106 of the creation of the EAS (identified by its EA ID or FQDN) and further shares information of the EAS, including the EAS' IP address and its location (e.g., EAS address 192.0.2.123 and location DataCenter_A in the example discussed herein above).

At Step 9 (Reference 236), the SMF 106 stores the information (at least the IP address and EAS location) in its state

### Rule Creation

In this stage, an optimized set of low-level charging rules is generated based on the higher-level charging rule, as one or more UEs are discovering the EASes (and hence likely to use them).

At Step 10 (Reference 238), UE 110 sends an EAS discovery request to the EAS discovery 112 to deploy an edge application. Depending on the actual solution used, this operation might take different forms, involve some intermediaries prior to the EAS discovery request reaching the EAS discovery 112.

At Step 11 (Reference 240), the EAS discovery 112 identifies the most suitable EAS (e.g., the one closest to UE 110) including the IP address of the EAS that fits the UE's EAS discovery request.

At Step 12 (Reference 242), if the EAS matches a notification rule (e.g., based on its EA ID or FQDN) the EAS discovery 112 notifies the SMF 106. This notification might contain one or more EASes and their IP address of the EASes, as well as the identifier (e.g., EA ID or FQDN) that triggered the notification.

In some embodiments, the EAS discovery response is sent to UE 110 (not shown) and the sending of the EAS discovery response to UE 110 can be conditioned to an acknowledgement from the SMF 106 that the corresponding low-level charging rule has been set up. In these embodiments, the system is ready to account for the traffic flow generated between UE 110 and the identified EAS upon the receipt of the EAS discovery response, as when UE 100 receives the EAS discovery response, the low-level charging rule has already been set up (due to the conditioning to the acknowledgement) for the accounting.

At Step 13 (Reference 244), the SMF 106 queries its datastore to retrieve the corresponding edge application (EA) from the SMF state 206. The retrieval obtains the EAS location (e.g., DataCenter_A in the example herein above) as the output based on the IP address of the matching EAS as returned by the notification rule).

At Step 14 (Reference 246), the datastore returns the EAS location from the SMF state 206. The location information doesn't need to be understandable by the SMF 106. The SMF 106 just needs to be able to match it against the location information presented in the high-level charging rules.

At Step 15 (Reference 248), the SMF 106 fetches the high-level charging rules associated with the edge application using (1) the identifier from the notification and (2) the EAS location information (which is received from the SMF state 206, see Step 14).

At Step 16 (Reference 250), the relevant one or more rules are provided to the SMF 106.

At Step 17 (Reference 252), based on the information from the high-level charging rules, the IP address of the EAS and possibly the location information, the SMF 106 generates the low-level charging rules that will be applied to charge for a traffic flow between UE 110 and the EAS.

The charging may be performed through the SMF 106, a Policy Control Function (PCF), a User Plane Function (UPF), and a Charging Function (CHF). For example, the SMF 106 may receive a set of rules from the PCF for charging, and the SMF 106 instructs the UPF about the usage reporting that it needs to perform. The UPF then reports the traffic as identified by the low-level charging rules. The SMF 106 then collects the usage reporting related to the low-level charging rules from the UPF, and the SMF 106 reports the chargeable events toward the CHF.

In some embodiments, the SMF 106 is to transform the EAS location into a parameter that is already available in existing charging rules (e.g., a charging key). Alternatively, the EAS location is to pass as a parameter to the charging function when reporting the usage. In the latter approach, an update to the CHF is required.

Note that when the EAS discovery 112 is performed using the EASDF function, the notification mechanism towards the SMF 106 is already implemented in a way that would fit embodiments of the invention. In the other cases (i.e., using just a local DNS server or an EES server), appropriate notification mechanisms would to be implemented.

Upon moving to a different location (a UE mobility event), UE 110 may discover new EAS, and the SMF 106 will be notified, and new low-level charging rules may be generated accordingly.

### Operations Per Some Embodiments

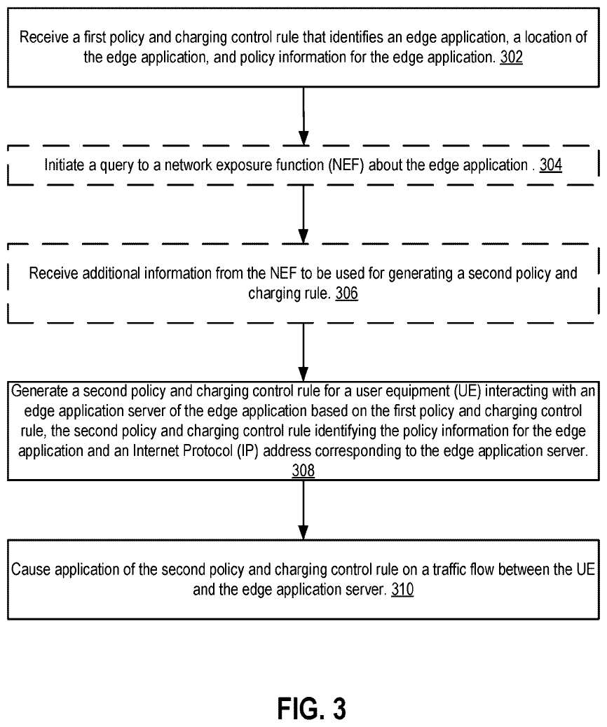

FIG. 3 is a flow diagram illustrating operations to generate a policy and charging control (PCC) rule per some embodiments. The operations may be performed by a network node that performs the PCC rule generation function such as the SMF 106.

At reference 302, a first policy and charging control rule that identifies an edge application, a location of the edge application, and policy information for the edge application is received.

When the received first policy and charging control rule is insufficient for the network node to set up a more detailed policy and charging control rule based on the first policy and charging control rule, the flow optionally goes to reference 304, and a query to a network exposure function (NEF) is initiated about the edge application.

At reference 306, additional information from the NEF is received to be used for generating a second policy and charging control rule based on the first policy and charging control rule. For example, the domain name of the edge application may be obtained based on the edge application ID.

At reference 308, a second policy and charging control rule is generated for a user equipment (UE) interacting with an edge application server of the edge application based on the first policy and charging control rule, the second policy and charging control rule identifying the policy information for the edge application and an Internet Protocol (IP) address corresponding to the edge application server. The IP address is an IP address of the edge application server through which a traffic flow to the edge application server is processed.

At reference 310, the network node causes application of the second policy and charging control rule on a traffic flow between the UE and the edge application server. For example, the network node may cause a charging rule to be applied to the traffic flow between the UE and the edge application server, such as the charging through interaction among SMF 106, the PCF, the UPF, and the CHF discussed herein above.

The second policy and charging control rule is generated automatically based on the first policy and charging control rule without human invention, and the second policy and charging control rule maps to the IP address corresponding to the instantiated edge application server and indicate the location of the edge application server. Such automatic generation of IP address-based policy and charging control rule is efficient, portable, and scalable and thus much better than a manually created IP address-based policy and charging control rule.

In some embodiments, the first policy and charging control rule identifies the edge application through one or more of an edge application identifier of the edge application and a domain name of the edge application. The domain name is the FQDN of the edge application in some embodiments.

In some embodiments, upon the edge application server being created, the network node receives a first notification that indicates information of the edge application server, including: one or more of an edge application identifier of the edge application and a domain name of the edge application, the IP address corresponding to the edge application server; and a location of the edge application server.

In some embodiments, the network node receives the first notification responsive to the network node subscribing to lifecycle event notification regarding the edge application. Alternatively or additionally, the network node may subscribe to lifecycle event notification regarding the corresponding one or more edge application servers.

In some embodiments, the network node stores the information of the edge application server and the first policy and charging control rule in a datastore coupled to the network node. In some embodiments, the first policy and charging control rule is stored in the datastore with a search key being one or more of the edge application identifier of the edge application and the domain name of the edge application.

In some embodiments, generating the second policy and charging control rule for interacting with the edge application server based on the first policy and charging control rule is responsive to receiving a second notification that indicates: one or more of the edge application identifier of the edge application server and the domain name of the edge application, and the IP address corresponding to the edge application server.

In some embodiments, the edge application server is discovered through one or more of an edge application server discovery function (EASDF), a domain name system (DNS) server, and an edge enabler server of the network.

In some embodiments, one or more of the IP addresses corresponding to the edge application server and other attributes of the edge application server are obtained responsive to a request initiated from the UE. The UE initiates the request upon moving to a new location.

In some embodiments, the network node discovers the edge application server responsive to subscription of the network node for notification from one or more the EASDF, the DNS, and the edge enabler server of the network.

In some embodiments, the application of the second policy and charging control rule comprises causing the UE to be charged for the traffic flow between the UE and the edge application server using the second policy and charging control rule.

In some embodiments, causing the UE to be charged for the traffic flow between the UE and the edge application server using the second policy and charging control rule comprises transforming one or more attributes of the edge application server into a parameter mapping to a charging key.

In some embodiments, the network node implements a session management function (SMF) for the policy and charging control rule generation.

Through these embodiments, one or more IP address-based policy and charging control rules corresponding to an edge application server are generated automatically without human invention based on a policy and charging control rule corresponding to an edge application that instantiates the edge application. Such automatic generation of the IP address-based policy and charging control rules is simpler for the network operator (e.g., MNO), more computationally effective, and/or consumes less network resources than the known manual creation of the IP address-based policy and charging control rules.

### Devices Implementing Embodiments of the Invention

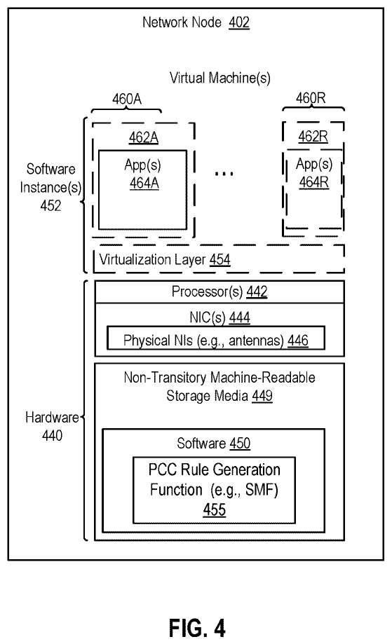

FIG. 4 illustrates a network node to generate policy and charging control (PCC) rules per some embodiments. The network node may be a SMF 106 or another node implementing a PCC rule generation function in a wireless/wireline network. The network node 402 may be implemented using custom application-specific integrated-circuits (ASICs) as processors and a special-purpose operating system (OS), or common off-the-shelf (COTS) processors and a standard OS. In some embodiments, the network node 402 implements a PCC rule generation function 455.

The network node 402 includes hardware 440 comprising a set of one or more processors 442 (which are typically COTS processors or processor cores or ASICs) and physical NIs 446, as well as non-transitory machine-readable storage media 449 having stored therein software 450. During operation, the one or more processors 442 may execute the software 450 to instantiate one or more sets of one or more applications 464A-R. While one embodiment does not implement virtualization, alternative embodiments may use different forms of virtualization. For example, in one such alternative embodiment, the virtualization layer 454 represents the kernel of an operating system (or a shim executing on a base operating system) that allows for the creation of multiple instances 462A-R called software containers that may each be used to execute one (or more) of the sets of applications 464A-R. The multiple software containers (also called virtualization engines, virtual private servers, or jails) are user spaces (typically a virtual memory space) that are separate from each other and separate from the kernel space in which the operating system is run. The set of applications running in a given user space, unless explicitly allowed, cannot access the memory of the other processes. In another such alternative embodiment, the virtualization layer 454 represents a hypervisor (sometimes referred to as a virtual machine monitor (VMM)) or a hypervisor executing on top of a host operating system, and each of the sets of applications 464A-R run on top of a guest operating system within an instance 462A-R called a virtual machine (which may in some cases be considered a tightly isolated form of software container) that run on top of the hypervisor—the guest operating system and application may not know that they are running on a virtual machine as opposed to running on a “bare metal” host electronic device, or through para-virtualization the operating system and/or application may be aware of the presence of virtualization for optimization purposes. In yet other alternative embodiments, one, some, or all of the applications are implemented as unikernel(s), which can be generated by compiling directly with an application only a limited set of libraries (e.g., from a library operating system (LibOS) including drivers/libraries of OS services) that provide the particular OS services needed by the application. As a unikernel can be implemented to run directly on hardware 440, directly on a hypervisor (in which case the unikernel is sometimes described as running within a LibOS virtual machine), or in a software container, embodiments can be implemented fully with unikernels running directly on a hypervisor represented by virtualization layer 454, unikernels running within software containers represented by instances 462A-R, or as a combination of unikernels and the above-described techniques (e.g., unikernels and virtual machines both run directly on a hypervisor, unikernels, and sets of applications that are run in different software containers).

The software 450 contains PCC rule generation function 455 that performs operations described with reference to operations as discussed relating to FIGS. 1 to 3. The remediation agent 100 may be instantiated within the applications 464A-R. The instantiation of the one or more sets of one or more applications 464A-R, as well as virtualization if implemented, are collectively referred to as software instance(s) 452. Each set of applications 464A-R, corresponding virtualization construct (e.g., instance 462A-R) if implemented, and that part of the hardware 440 that executes them (be it hardware dedicated to that execution and/or time slices of hardware temporally shared), forms a separate virtual network node 460A-R.

A network interface (NI) may be physical or virtual. In the context of IP, an interface address is an IP address assigned to an NI, be it a physical NI or virtual NI. A virtual NI may be associated with a physical NI, with another virtual interface, or stand on its own (e.g., a loopback interface, a point-to-point protocol interface). A NI (physical or virtual) may be numbered (a NI with an IP address) or unnumbered (a NI without an IP address). The NI is shown as network interface card (NIC) 444. The physical network interface 446 may include one or more antenna of the network node 402. An antenna port may or may not correspond to a physical antenna. The antenna comprises one or more radio interfaces.

### A Wireless Network Per Some Embodiments

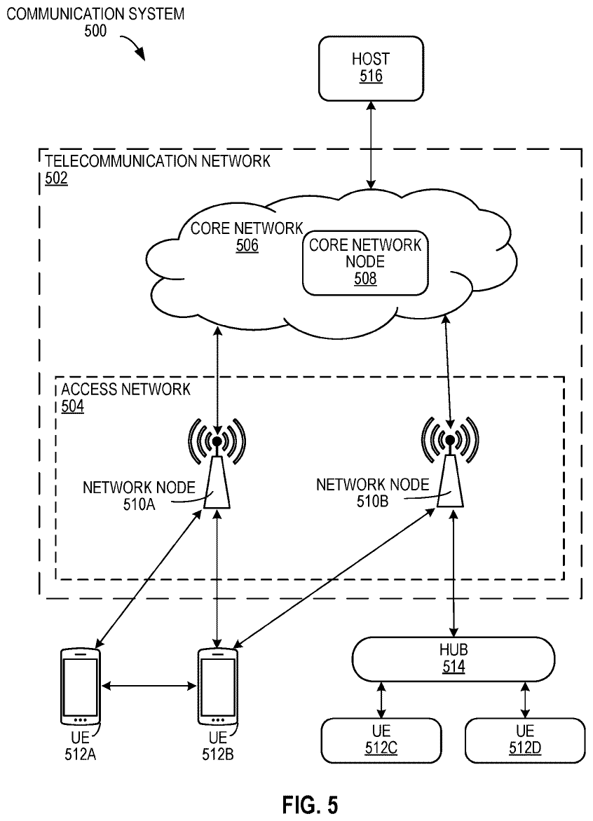

FIG. 5 illustrates an example of a communication system 500 per some embodiments.

In the example, the communication system 500 includes a telecommunication network 502 that includes an access network 504, such as a radio access network (RAN), and a core network 506, which includes one or more core network nodes 508. The access network 504 includes one or more access network nodes, such as network nodes 510a and 510b (one or more of which may be generally referred to as network nodes 510), or any other similar 3rd Generation Partnership Project (3GPP) access node or non-3GPP access point. The network nodes 510 facilitate direct or indirect connection of user equipment (UE), such as by connecting UEs 512a, 512b, 512c, and 512d (one or more of which may be generally referred to as UEs 512) to the core network 506 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 500 may include any number of wired or wireless networks, network nodes, UEs, and/or any other components or systems that may facilitate or participate in the communication of data and/or signals whether via wired or wireless connections. The communication system 500 may include and/or interface with any type of communication, telecommunication, data, cellular, radio network, and/or other similar type of system.

The UEs 512 may be any of a wide variety of communication devices, including wireless devices arranged, configured, and/or operable to communicate wirelessly with the network nodes 510 and other communication devices. Similarly, the network nodes 510 are arranged, capable, configured, and/or operable to communicate directly or indirectly with the UEs 512 and/or with other network nodes or equipment in the telecommunication network 502 to enable and/or provide network access, such as wireless network access, and/or to perform other functions, such as administration in the telecommunication network 502.

In the depicted example, the core network 506 connects the network nodes 510 to one or more hosts, such as host 516. These connections may be direct or indirect via one or more intermediary networks or devices. In other examples, network nodes may be directly coupled to hosts. The core network 506 includes one more core network nodes (e.g., core network node 508) that are structured with hardware and software components. Features of these components may be substantially similar to those described with respect to the UEs, network nodes, and/or hosts, such that the descriptions thereof are generally applicable to the corresponding components of the core network node 508. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 516 may be under the ownership or control of a service provider other than an operator or provider of the access network 504 and/or the telecommunication network 502, and may be operated by the service provider or on behalf of the service provider. The host 516 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 500 of FIG. 5 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 502 is a cellular network that implements 3GPP standardized features. Accordingly, the telecommunications network 502 may support network slicing to provide different logical networks to different devices that are connected to the telecommunication network 502. For example, the telecommunications network 502 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 512 are configured to transmit and/or receive information without direct human interaction. For instance, a UE may be designed to transmit information to the access network 504 on a predetermined schedule, when triggered by an internal or external event, or in response to requests from the access network 504. Additionally, a UE may be configured for operating in single- or multi-RAT or multi-standard mode. For example, a UE may operate with any one or combination of Wi-Fi, NR (New Radio) and LTE, i.e., being configured for multi-radio dual connectivity (MR-DC), such as E-UTRAN (Evolved-UMTS Terrestrial Radio Access Network) New Radio-Dual Connectivity (EN-DC).

In the example, the hub 514 communicates with the access network 504 to facilitate indirect communication between one or more UEs (e.g., UE 512c and/or 512d) and network nodes (e.g., network node 510b). In some examples, the hub 514 may be a controller, router, content source and analytics, or any of the other communication devices described herein regarding UEs. For example, the hub 514 may be a broadband router enabling access to the core network 506 for the UEs. As another example, the hub 514 may be a controller that sends commands or instructions to one or more actuators in the UEs. Commands or instructions may be received from the UEs, network nodes 510, or by executable code, script, process, or other instructions in the hub 514. As another example, the hub 514 may be a data collector that acts as temporary storage for UE data and, in some embodiments, may perform analysis or other processing of the data. As another example, the hub 514 may be a content source. For example, for a UE that is a VR headset, display, loudspeaker or other media delivery device, the hub 514 may retrieve VR assets, video, audio, or other media or data related to sensory information via a network node, which the hub 514 then provides to the UE either directly, after performing local processing, and/or after adding additional local content. In still another example, the hub 514 acts as a proxy server or orchestrator for the UEs, in particular in if one or more of the UEs are low energy IoT devices.

The hub 514 may have a constant/persistent or intermittent connection to the network node 510b. The hub 514 may also allow for a different communication scheme and/or schedule between the hub 514 and UEs (e.g., UE 512c and/or 512d), and between the hub 514 and the core network 506. In other examples, the hub 514 is connected to the core network 506 and/or one or more UEs via a wired connection. Moreover, the hub 514 may be configured to connect to an M2M service provider over the access network 504 and/or to another UE over a direct connection. In some scenarios, UEs may establish a wireless connection with the network nodes 510 while still connected via the hub 514 via a wired or wireless connection. In some embodiments, the hub 514 may be a dedicated hub—that is, a hub whose primary function is to route communications to/from the UEs from/to the network node 510b. In other embodiments, the hub 514 may be a non-dedicated hub—that is, a device which is capable of operating to route communications between the UEs and network node 510b, but which is additionally capable of operating as a communication start and/or end point for certain data channels.

### UE Per Some Embodiments

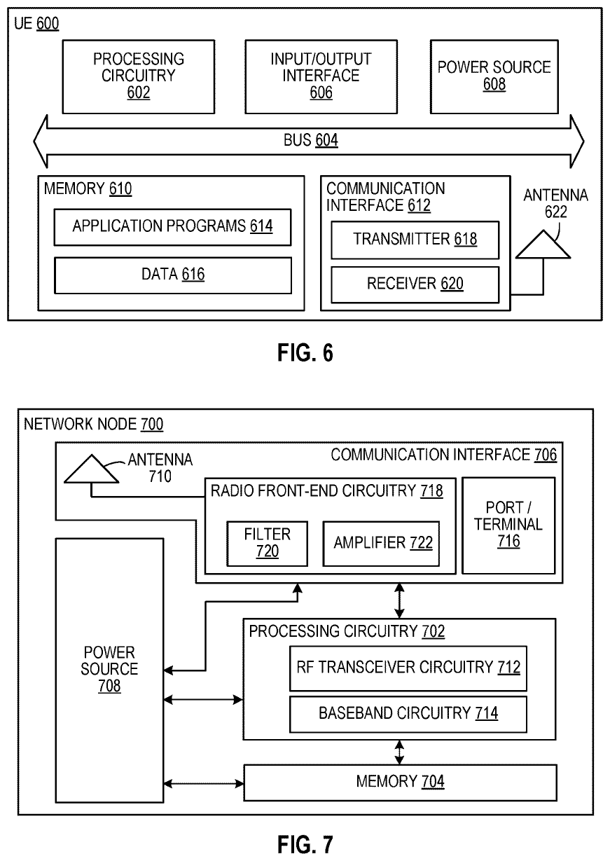

FIG. 6 illustrates a UE 600 per some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 600 includes processing circuitry 602 that is operatively coupled via a bus 604 to an input/output interface 606, a power source 608, a memory 610, a communication interface 612, and/or any other component, or any combination thereof. Certain UEs may utilize all or a subset of the components shown in FIG. 6. The level of integration between the components may vary from one UE to another UE. Further, certain UEs may contain multiple instances of a component, such as multiple processors, memories, transceivers, transmitters, receivers, etc.

The processing circuitry 602 is configured to process instructions and data and may be configured to implement any sequential state machine operative to execute instructions stored as machine-readable computer programs in the memory 610. The processing circuitry 602 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 602 may include multiple central processing units (CPUs).

In the example, the input/output interface 606 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 600. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 608 is structured as a battery or battery pack. Other types of power sources, such as an external power source (e.g., an electricity outlet), photovoltaic device, or power cell, may be used. The power source 608 may further include power circuitry for delivering power from the power source 608 itself, and/or an external power source, to the various parts of the UE 600 via input circuitry or an interface such as an electrical power cable. Delivering power may be, for example, for charging of the power source 608. Power circuitry may perform any formatting, converting, or other modification to the power from the power source 608 to make the power suitable for the respective components of the UE 600 to which power is supplied.

The memory 610 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 610 includes one or more application programs 614, such as an operating system, web browser application, a widget, gadget engine, or other application, and corresponding data 616. The memory 610 may store, for use by the UE 600, any of a variety of various operating systems or combinations of operating systems.

The memory 610 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 610 may allow the UE 600 to access instructions, application programs and the like, stored on transitory or non-transitory memory media, to off-load data, or to upload data. An article of manufacture, such as one utilizing a communication system may be tangibly embodied as or in the memory 610, which may be or comprise a device-readable storage medium.

The processing circuitry 602 may be configured to communicate with an access network or other network using the communication interface 612. The communication interface 612 may comprise one or more communication subsystems and may include or be communicatively coupled to an antenna 622. The communication interface 612 may include one or more transceivers used to communicate, such as by communicating with one or more remote transceivers of another device capable of wireless communication (e.g., another UE or a network node in an access network). Each transceiver may include a transmitter 618 and/or a receiver 620 appropriate to provide network communications (e.g., optical, electrical, frequency allocations, and so forth). Moreover, the transmitter 618 and receiver 620 may be coupled to one or more antennas (e.g., antenna 622) and may share circuit components, software or firmware, or alternatively be implemented separately.

In the illustrated embodiment, communication functions of the communication interface 612 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 612, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 600 shown in FIG. 6.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g., by controlling an actuator) to increase or decrease the drone's speed. The first and/or the second UE can also include more than one of the functionalities described above. For example, a UE might comprise the sensor and the actuator, and handle communication of data for both the speed sensor and the actuators.

### Network Node Per Some Embodiments

FIG. 7 illustrates a network node 700 per some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 700 includes a processing circuitry 702, a memory 704, a communication interface 706, and a power source 708. The network node 700 may be composed of multiple physically separate components (e.g., a NodeB component and a RNC component, or a BTS component and a BSC component, etc.), which may each have their own respective components. In certain scenarios in which the network node 700 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 700 may be configured to support multiple radio access technologies (RATs). In such embodiments, some components may be duplicated (e.g., separate memory 704 for different RATs) and some components may be reused (e.g., a same antenna 710 may be shared by different RATs). The network node 700 may also include multiple sets of the various illustrated components for different wireless technologies integrated into network node 700, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 700.

The processing circuitry 702 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 700 components, such as the memory 704, to provide network node 700 functionality.

In some embodiments, the processing circuitry 702 includes a system on a chip (SOC). In some embodiments, the processing circuitry 702 includes one or more of radio frequency (RF) transceiver circuitry 712 and baseband processing circuitry 714. In some embodiments, the radio frequency (RF) transceiver circuitry 712 and the baseband processing circuitry 714 may be on separate chips (or sets of chips), boards, or units, such as radio units and digital units. In alternative embodiments, part or all of RF transceiver circuitry 712 and baseband processing circuitry 714 may be on the same chip or set of chips, boards, or units.

The memory 704 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 702. The memory 704 may store any suitable instructions, data, or information, including a computer program, software, an application including one or more of logic, rules, code, tables, and/or other instructions capable of being executed by the processing circuitry 702 and utilized by the network node 700. The memory 704 may be used to store any calculations made by the processing circuitry 702 and/or any data received via the communication interface 706. In some embodiments, the processing circuitry 702 and memory 704 is integrated.

The communication interface 706 is used in wired or wireless communication of signaling and/or data between a network node, access network, and/or UE. As illustrated, the communication interface 706 comprises port(s)/terminal(s) 716 to send and receive data, for example to and from a network over a wired connection. The communication interface 706 also includes radio front-end circuitry 718 that may be coupled to, or in certain embodiments a part of, the antenna 710. Radio front-end circuitry 718 comprises filters 720 and amplifiers 722. The radio front-end circuitry 718 may be connected to an antenna 710 and processing circuitry 702. The radio front-end circuitry may be configured to condition signals communicated between antenna 710 and processing circuitry 702. The radio front-end circuitry 718 may receive digital data that is to be sent out to other network nodes or UEs via a wireless connection. The radio front-end circuitry 718 may convert the digital data into a radio signal having the appropriate channel and bandwidth parameters using a combination of filters 720 and/or amplifiers 722. The radio signal may then be transmitted via the antenna 710. Similarly, when receiving data, the antenna 710 may collect radio signals which are then converted into digital data by the radio front-end circuitry 718. The digital data may be passed to the processing circuitry 702. In other embodiments, the communication interface may comprise different components and/or different combinations of components.

In certain alternative embodiments, the network node 700 does not include separate radio front-end circuitry 718, instead, the processing circuitry 702 includes radio front-end circuitry and is connected to the antenna 710. Similarly, in some embodiments, all or some of the RF transceiver circuitry 712 is part of the communication interface 706. In still other embodiments, the communication interface 706 includes one or more ports or terminals 716, the radio front-end circuitry 718, and the RF transceiver circuitry 712, as part of a radio unit (not shown), and the communication interface 706 communicates with the baseband processing circuitry 714, which is part of a digital unit (not shown).

The antenna 710 may include one or more antennas, or antenna arrays, configured to send and/or receive wireless signals. The antenna 710 may be coupled to the radio front-end circuitry 718 and may be any type of antenna capable of transmitting and receiving data and/or signals wirelessly. In certain embodiments, the antenna 710 is separate from the network node 700 and connectable to the network node 700 through an interface or port.

The antenna 710, communication interface 706, and/or the processing circuitry 702 may be configured to perform any receiving operations and/or certain obtaining operations described herein as being performed by the network node. Any information, data and/or signals may be received from a UE, another network node and/or any other network equipment. Similarly, the antenna 710, the communication interface 706, and/or the processing circuitry 702 may be configured to perform any transmitting operations described herein as being performed by the network node. Any information, data and/or signals may be transmitted to a UE, another network node and/or any other network equipment.

The power source 708 provides power to the various components of network node 700 in a form suitable for the respective components (e.g., at a voltage and current level needed for each respective component). The power source 708 may further comprise, or be coupled to, power management circuitry to supply the components of the network node 700 with power for performing the functionality described herein. For example, the network node 700 may be connectable to an external power source (e.g., the power grid, an electricity outlet) via an input circuitry or interface such as an electrical cable, whereby the external power source supplies power to power circuitry of the power source 708. As a further example, the power source 708 may comprise a source of power in the form of a battery or battery pack which is connected to, or integrated in, power circuitry. The battery may provide backup power should the external power source fail.

Embodiments of the network node 700 may include additional components beyond those shown in FIG. 7 for providing certain aspects of the network node's functionality, including any of the functionality described herein and/or any functionality necessary to support the subject matter described herein. For example, the network node 700 may include user interface equipment to allow input of information into the network node 700 and to allow output of information from the network node 700. This may allow a user to perform diagnostic, maintenance, repair, and other administrative functions for the network node 700.

### Host Per Some Embodiments

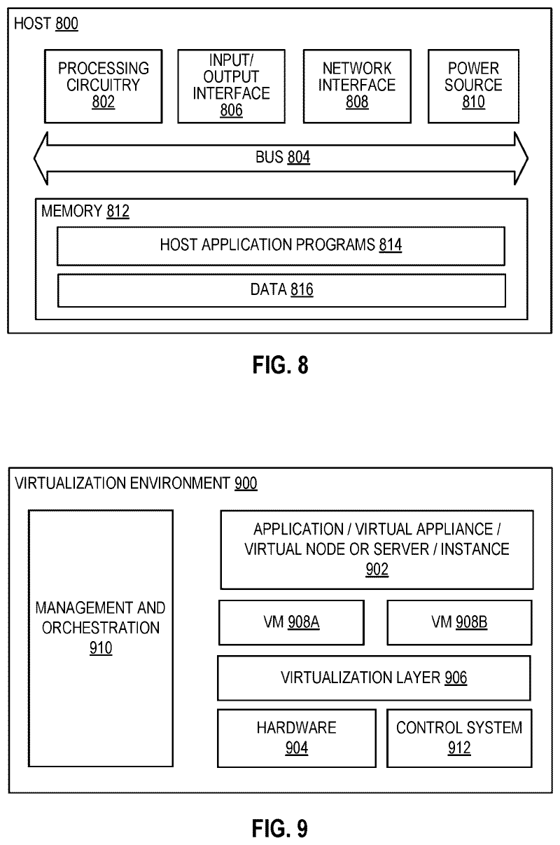

FIG. 8 is a block diagram of a host 800, which may be an embodiment of the host 516 of FIG. 5, per various aspects described herein. As used herein, the host 800 may be or comprise various combinations hardware and/or software, including a standalone server, a blade server, a cloud-implemented server, a distributed server, a virtual machine, container, or processing resources in a server farm. The host 800 may provide one or more services to one or more UEs.

The host 800 includes processing circuitry 802 that is operatively coupled via a bus 804 to an input/output interface 806, a network interface 808, a power source 810, and a memory 812. Other components may be included in other embodiments. Features of these components may be substantially similar to those described with respect to the devices of previous figures, such as FIGS. 6 and 7, such that the descriptions thereof are generally applicable to the corresponding components of host 800.

The memory 812 may include one or more computer programs including one or more host application programs 814 and data 816, which may include user data, e.g., data generated by a UE for the host 800 or data generated by the host 800 for a UE. Embodiments of the host 800 may utilize only a subset or all of the components shown. The host application programs 814 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 814 may also provide for user authentication and licensing checks and may periodically report health, routes, and content availability to a central node, such as a device in or on the edge of a core network. Accordingly, the host 800 may select and/or indicate a different host for over-the-top services for a UE. The host application programs 814 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

### Virtualization Environment Per Some Embodiments

FIG. 9 is a block diagram illustrating a virtualization environment 900 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 900 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 902 (which may alternatively be called software instances, virtual appliances, network functions, virtual nodes, virtual network functions, etc.) are run in the virtualization environment 900 to implement some of the features, functions, and/or benefits of some of the embodiments disclosed herein.

Hardware 904 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 906 (also referred to as hypervisors or virtual machine monitors (VMMs)), provide VMs 908a and 908b (one or more of which may be generally referred to as VMs 908), and/or perform any of the functions, features and/or benefits described in relation with some embodiments described herein. The virtualization layer 906 may present a virtual operating platform that appears like networking hardware to the VMs 908.

The VMs 908 comprise virtual processing, virtual memory, virtual networking or interface and virtual storage, and may be run by a corresponding virtualization layer 906. Different embodiments of the instance of a virtual appliance 902 may be implemented on one or more of VMs 908, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 908 may be a software implementation of a physical machine that runs programs as if they were executing on a physical, non-virtualized machine. Each of the VMs 908, and that part of hardware 904 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 908 on top of the hardware 904 and corresponds to the application 902.

Hardware 904 may be implemented in a standalone network node with generic or specific components. Hardware 904 may implement some functions via virtualization. Alternatively, hardware 904 may be part of a larger cluster of hardware (e.g., such as in a data center or CPE) where many hardware nodes work together and are managed via management and orchestration 910, which, among others, oversees lifecycle management of applications 902. In some embodiments, hardware 904 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 912 which may alternatively be used for communication between hardware nodes and radio units.

### Communication Among Host, Network Node, and UE Per Some Embodiments

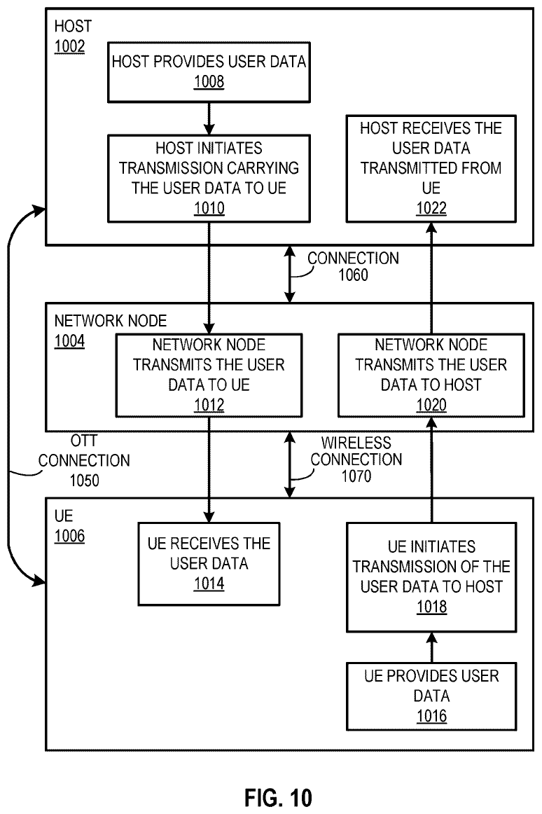

FIG. 10 illustrates a communication diagram of a host 1002 communicating via a network node 1004 with a UE 1006 over a partially wireless connection per some embodiments. Example implementations, in accordance with various embodiments, of the UE (such as a UE 512a of FIG. 5 and/or UE 600 of FIG. 6), network node (such as network node 510a of FIG. 5 and/or network node 700 of FIG. 7), and host (such as host 516 of FIG. 5 and/or host 800 of FIG. 8) discussed in the preceding paragraphs will now be described with reference to FIG. 10.

Like host 800, embodiments of host 1002 include hardware, such as a communication interface, processing circuitry, and memory. The host 1002 also includes software, which is stored in or accessible by the host 1002 and executable by the processing circuitry. The software includes a host application that may be operable to provide a service to a remote user, such as the UE 1006 connecting via an over-the-top (OTT) connection 1050 extending between the UE 1006 and host 1002. In providing the service to the remote user, a host application may provide user data which is transmitted using the OTT connection 1050.

The network node 1004 includes hardware enabling it to communicate with the host 1002 and UE 1006. The connection 1060 may be direct or pass through a core network (like core network 506 of FIG. 5) and/or one or more other intermediate networks, such as one or more public, private, or hosted networks. For example, an intermediate network may be a backbone network or the Internet.

The UE 1006 includes hardware and software, which is stored in or accessible by UE 1006 and executable by the UE's processing circuitry. The software includes a client application, such as a web browser or operator-specific “app” that may be operable to provide a service to a human or non-human user via UE 1006 with the support of the host 1002. In the host 1002, an executing host application may communicate with the executing client application via the OTT connection 1050 terminating at the UE 1006 and host 1002. In providing the service to the user, the UE's client application may receive request data from the host's host application and provide user data in response to the request data. The OTT connection 1050 may transfer both the request data and the user data. The UE's client application may interact with the user to generate the user data that it provides to the host application through the OTT connection 1050.

The OTT connection 1050 may extend via a connection 1060 between the host 1002 and the network node 1004 and via a wireless connection 1070 between the network node 1004 and the UE 1006 to provide the connection between the host 1002 and the UE 1006. The connection 1060 and wireless connection 1070, over which the OTT connection 1050 may be provided, have been drawn abstractly to illustrate the communication between the host 1002 and the UE 1006 via the network node 1004, without explicit reference to any intermediary devices and the precise routing of messages via these devices.

As an example of transmitting data via the OTT connection 1050, in step 1008, the host 1002 provides user data, which may be performed by executing a host application. In some embodiments, the user data is associated with a particular human user interacting with the UE 1006. In other embodiments, the user data is associated with a UE 1006 that shares data with the host 1002 without explicit human interaction. In step 1010, the host 1002 initiates a transmission carrying the user data towards the UE 1006. The host 1002 may initiate the transmission responsive to a request transmitted by the UE 1006. The request may be caused by human interaction with the UE 1006 or by operation of the client application executing on the UE 1006. The transmission may pass via the network node 1004, in accordance with the teachings of the embodiments described throughout this disclosure. Accordingly, in step 1012, the network node 1004 transmits to the UE 1006 the user data that was carried in the transmission that the host 1002 initiated, in accordance with the teachings of the embodiments described throughout this disclosure. In step 1014, the UE 1006 receives the user data carried in the transmission, which may be performed by a client application executed on the UE 1006 associated with the host application executed by the host 1002.

In some examples, the UE 1006 executes a client application which provides user data to the host 1002. The user data may be provided in reaction or response to the data received from the host 1002. Accordingly, in step 1016, the UE 1006 may provide user data, which may be performed by executing the client application. In providing the user data, the client application may further consider user input received from the user via an input/output interface of the UE 1006. Regardless of the specific manner in which the user data was provided, the UE 1006 initiates, in step 1018, transmission of the user data towards the host 1002 via the network node 1004. In step 1020, in accordance with the teachings of the embodiments described throughout this disclosure, the network node 1004 receives user data from the UE 1006 and initiates transmission of the received user data towards the host 1002. In step 1022, the host 1002 receives the user data carried in the transmission initiated by the UE 1006.

### Terms

References in the specification to “one embodiment,” “an embodiment,” “an example embodiment,” and so forth, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The description and claims may use the terms “coupled” and “connected,” along with their derivatives. These terms are not intended as synonyms for each other. “Coupled” is used to indicate that two or more elements, which may or may not be in direct physical or electrical contact with each other, co-operate or interact with each other. “Connected” is used to indicate the establishment of wireless or wireline communication between two or more elements that are coupled with each other. A “set,” as used herein can refer to any whole number of items including one item

An electronic device (such as the network node 402) stores and transmits (internally and/or with other electronic devices over a network) code (which is composed of software instructions and which is sometimes referred to as a computer program code or a computer program) and/or data using machine-readable media (also called computer-readable media), such as machine-readable storage media (e.g., magnetic disks, optical disks, solid state drives, read only memory (ROM), flash memory devices, phase change memory) and machine-readable transmission media (also called a carrier) (e.g., electrical, optical, radio, acoustical, or other form of propagated signals-such as carrier waves, infrared signals). Thus, an electronic device (e.g., a computer) includes hardware and software, such as a set of one or more processors (e.g., of which a processor is a microprocessor, controller, microcontroller, central processing unit, digital signal processor, application specific integrated circuit (ASIC), field programmable gate array (FPGA), other electronic circuitry, or a combination of one or more of the preceding) coupled to one or more machine-readable storage media to store code for execution on the set of processors and/or to store data. For instance, an electronic device may include non-volatile memory containing the code since the non-volatile memory can persist code/data even when the electronic device is turned off (when power is removed). When the electronic device is turned on, that part of the code that is to be executed by the processor(s) of the electronic device is typically copied from the slower non-volatile memory into volatile memory (e.g., dynamic random-access memory (DRAM), static random-access memory (SRAM)) of the electronic device. Typical electronic devices also include a set of one or more physical network interface(s) (NI(s)) to establish network connections (to transmit and/or receive code and/or data using propagating signals) with other electronic devices. For example, the set of physical NIs (or the set of physical NI(s) in combination with the set of processors executing code) may perform any formatting, coding, or translating to allow the electronic device to send and receive data whether over a wired and/or a wireless connection. In some embodiments, a physical NI may comprise radio circuitry capable of (1) receiving data from other electronic devices over a wireless connection and/or (2) sending data out to other devices through a wireless connection. This radio circuitry may include transmitter(s), receiver(s), and/or transceiver(s) suitable for radio frequency communication. The radio circuitry may convert digital data into a radio signal having the proper parameters (e.g., frequency, timing, channel, bandwidth, and so forth). The radio signal may then be transmitted through antennas to the appropriate recipient(s). In some embodiments, the set of physical NI(s) may comprise network interface controller(s) (NICs), also known as a network interface card, network adapter, or local area network (LAN) adapter. The NIC(s) may facilitate in connecting the electronic device to other electronic devices allowing them to communicate with wire through plugging in a cable to a physical port connected to an NIC. One or more parts of an embodiment of the invention may be implemented using different combinations of software, firmware, and/or hardware.

The terms “module,” “logic,” and “unit” used in the present application, may refer to a circuit for performing the function specified. In some embodiments, the function specified may be performed by a circuit in combination with software such as by software executed by a general-purpose processor.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

The term unit may have conventional meaning in the field of electronics, electrical devices, and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

1. A method to be implemented in a network node of a network for policy and charging control rule generation, the method comprising:
receiving a first policy and charging control rule that identifies an edge application, a location of the edge application, and policy information for the edge application;
generating a second policy and charging control rule for a user equipment interacting with an edge application server of the edge application based on the first policy and charging control rule, the second policy and charging control rule identifying the policy information for the edge application and an Internet Protocol address corresponding to the edge application server; and
causing application of the second policy and charging control rule on a traffic flow between the UE and the edge application server.

2. The method of claim 1, wherein the first policy and charging control rule identifies the edge application through one or more of an edge application identifier of the edge application and a domain name of the edge application.

3. The method of claim 1, further comprising:
initiating a query to a network exposure function (NEF) about the edge application; and
receiving additional information from the NEF to be used for generating the second policy and charging control rule.

4. The method of claim 1, wherein upon the edge application server being created, the network node receives a first notification that indicates information of the edge application server, including:
one or more of an edge application identifier of the edge application and a domain name of the edge application,
the IP address corresponding to the edge application server; and
a location of the edge application server.

5. The method of claim 4, wherein the network node receives the first notification responsive to the network node subscribing to lifecycle event notification regarding the edge application.

6. The method of claim 4, wherein the network node stores the information of the edge application server and the first policy and charging control rule in a datastore coupled to the network node.

7. The method of claim 6, wherein the first policy and charging control rule is stored in the datastore with a search key being one or more of the edge application identifier of the edge application and the domain name of the edge application.

8. The method of claim 4, wherein generating the second policy and charging control rule for interacting with the edge application server based on the first policy and charging control rule is responsive to receiving a second notification that indicates:
one or more of the edge application identifier of the edge application server and the domain name of the edge application, and
the IP address corresponding to the edge application server.

9. The method of claim 1, wherein the edge application server is discovered through one or more of an edge application server discovery function (EASDF), a domain name system (DNS) server, and an edge enabler server of the network.

10. The method of claim 9, wherein one or more of the IP address corresponding to the edge application server and other attributes of the edge application server are obtained responsive to a request initiated from the UE.

11. The method of claim 10, wherein the UE initiates the request upon moving to a new location.

12. The method of claim 9, wherein the network node discovers the edge application server responsive to subscription of the network node for notification from one or more the EASDF, the DNS, and the edge enabler server of the network.

13. The method of claim 1, wherein the application of the second policy and charging control rule comprises causing the UE to be charged for the traffic flow between the UE and the edge application server using the second policy and charging control rule.

14. The method of claim 13, wherein causing the UE to be charged for the traffic flow between the UE and the edge application server using the second policy and charging control rule comprises transforming one or more attributes of the edge application server into a parameter mapping to a charging key.

15. The method of claim 1, wherein the network node implements a session management function (SMF) for the policy and charging control rule generation.

16. A network node to perform policy and charging control rule generation in a network, comprising:
a processor and machine-readable storage medium that provides instructions that, when executed by the processor, are capable of causing the processor to perform operations of:
receiving a first policy and charging control rule that identifies an edge application, a location of the edge application, and policy information for the edge application;
generating a second policy and charging control rule for a user equipment (UE) interacting with an edge application server of the edge application based on the first policy and charging control rule, the second policy and charging control rule identifying the policy information for the edge application and an Internet Protocol (IP) address corresponding to the edge application server; and
causing application of the second policy and charging control rule on a traffic flow between the UE and the edge application server.

17. The network node of claim 16, wherein the first policy and charging control rule identifies the edge application through one or more of an edge application identifier of the edge application and a domain name of the edge application.

18. The network node of claim 16, wherein the operations further comprise:
initiating a query to a network exposure function (NEF) about the edge application; and
receiving additional information from the NEF to be used for generating the second policy and charging control rule.

19. The network node of claim 16, wherein upon the edge application server being created, the network node receives a first notification that indicates information of the edge application server, including:
one or more of an edge application identifier of the edge application and a domain name of the edge application,
the IP address corresponding to the edge application server; and
a location of the edge application server.

20. The network node of claim 19, wherein the network node receives the first notification responsive to the network node subscribing to lifecycle event notification regarding the edge application.

21-31. (canceled)
